(19) United States
(12) Patent Application Publication
(10) Pub. No.: US 2008/0114572 A1
(43) Pub. Date: May 15, 2008

(54) Efficient and Incremental Sensitivity Analysis for Linear Circuits

(75) Inventors: Peter Feldmann, New York, NY (US); David D. Ling, Upper Saddle River, NJ (US)

Correspondence Address: CAHN & SAMUELS, LLP, 1100 17th STREET, NW, SUITE 401, WASHINGTON, DC, 20036, US

(73) Assignee: INTERNATIONAL BUSINESS MACHINES CORPORATION, Armonk, NY (US)

(21) Appl. No.: 11/560,152

(22) Filed: Nov. 15, 2006

(51) Int. Cl. G06F 17/15; G06F 17/16

(52) U.S. Cl. 703/2; 708/420

(57) ABSTRACT

A method, system and computer readable medium that determine a sensitivity value of a linear circuit. A number of ingredients are computed with respect to the interconnect circuit which are largely independent of each other. The ingredients are combined and if any one of the ingredients changes, it is recalculated and combined with the other ingredients which do not have to be recalculated.

### I. FIELD OF THE INVENTION

This invention relates generally to a method and system for computing the sensitivities of linear circuit timing performance, such as delay, slew, noise, and power, with respect to arbitrary design and process parameters in an efficient and incremental manner. More particularly, the invention relates to a method and system that calculates the sensitivities of various linear circuits within a given functional circuit. The method is most efficient for smaller linear circuits, and can be easily combined with approximate model-order reduction techniques when applied to larger circuits.

### II. BACKGROUND OF THE INVENTION

As integrated circuit (IC) technology advances into the deep sub-micron domain, the issue of variability has come to occupy a central role in design and verification. Methods for accounting for the effects of variability in circuit timing have become an important focus in the past few years, particularly in the area of statistical static timing analysis. One important component of a statistical timer is the sensitivity of interconnect circuit performance, such as the propagation delay and output slew of the interconnect circuit, with respect to a set of randomly varying parameters such as oxide thickness, doping density, metallic line-width and thickness, interlayer dielectric thickness, as well as others. The ability to accurately and efficiently compute these circuit sensitivities can assist in improving the performance and accuracy of a statistical timer. These sensitivities constitute the key information that allows circuit designs to be optimized for maximum yield in the presence of manufacturing variations. Through the use of sensitivities, both the statistical and the deterministic circuit performance can be optimized efficiently by gradient-based optimization techniques.

In accordance with certain related art methods, the computation of circuit sensitivities comprises differentiating the circuit equations with respect to the parameters of interest. In general, the result of this differentiation is a companion linear time-varying system of differential equations that needs to be solved in order to produce the sensitivity values. In most cases this system of linearized equations can be recast as a “companion” linear time-varying circuit and the solution of these equations can be viewed as responses of this circuit to a particular excitation. Depending on how this “companion” circuit is excited and how its response is combined with the original circuit response to produce sensitivity values, two standard methods are available for computing circuit sensitivities.

The first method, often times referred to as the “direct” method, is discussed in detail by, for example, D. A. Hocevar, P. Yang, T. N. Trick and B. D. Epler, “Transient sensitivity computation for MOSFET circuits,” IEEE Trans. on CAD, pp. 609-620, vol. CAD-4, number 4, October 1985, the contents of which are incorporated herein by reference for all that it teaches. The “direct” method produces the sensitivities of any number of circuit responses with respect to one parameter from one single analysis of the “companion circuit.”

The second method, known as the “adjoint” method, is discussed, for example, by S. W. Director and R. A. Rohrer, “The generalized adjoint network and network sensitivities,” IEEE Transactions on Circuit Theory, vol. CT-16, pp. 318-323, August 1969, the contents of which are also incorporated herein by reference for all that it teaches. From a similar single analysis, the “adjoint” method produces the sensitivities of one response with respect to any number of circuit parameters. In most applications, the number of circuit responses of interest is much smaller than the number of parameters. Nevertheless, typically the “adjoint” method is perceived as difficult to implement and is rarely used in practice.

Sensitivities corresponding to the interconnecting wires of a circuit and the power grid networks with respect to design and technology parameters are essential information for timing analysis, timing optimization, statistical timing, and numerous other applications. The modeling of the interconnect circuit as well as the power grid of a VLSI chip is done mainly in terms of linear circuits, which constitute an important special case from an analysis viewpoint.

### III. SUMMARY OF THE INVENTION

The inventors have realized that linear circuit properties can be exploited to derive even more efficient sensitivity algorithms, beyond the traditional “direct” and “adjoint” methods. More particularly, the companion system of a linear circuit is no longer time-varying but a constant coefficient system of ordinary differential equations. As such, both the original circuit equations and the sensitivity companion equations lend themselves to analytic, modal analysis especially when the excitation has a “simple” form, such as a step function or a saturated ramp, as is almost always the case in practical digital applications.

As discussed in more detail below, the inventors have discovered that sensitivity analysis of linear circuits in combination with modal analysis leads to a richer and more powerful arsenal of sensitivity computation algorithms in which a significant numerical computation effort is replaced by analytical results. Moreover, large circuits and their companions can be analyzed by rigorous approximate techniques based on retaining only the dominant modes. As discussed below, a connection is made between this family of sensitivity computation algorithms and the powerful model-order reduction algorithm methods that are typically used in regard to modern interconnect analysis.

To address the issues and problems associated with traditional interconnect circuit sensitivity analysis, as discussed above, the inventors have discovered an analytical approach, i.e., as opposed to a numerical approach, to the sensitivity computation. The analytical method can be applied in full to small circuits and it is fully compatible with model-order reduction techniques. Beyond efficiency and accuracy, another major consequence of this approach is that the sensitivity calculation separates into steps that are largely independent of each other.

One step of a method in accordance with the invention depends on the input signals, but does not depend on the measured performance or the variable parameters. Another step involves the computation of matrices that depend on the topology of the circuit, but are independent of the input signals. This latter step of the calculation is accelerated for larger circuits by model-order reduction techniques, and does not need to be repeated if the input signals change. The sensitivity calculation consists of computing a number of ingredients that are largely independent of each other, and then combining these ingredients to derive a final sensitivity calculation. If any one of the ingredients is subject to change, it is recalculated and then combined with the other ingredients, which do not need to be recalculated. The ability to update pieces of the computation without having to redo the entire calculation when one aspect of the problem is changed means this method is well-suited for an incremental timing methodology, such as is common in the design of integrated circuits.

According to exemplary embodiment of the invention, the invention includes a method for determining at least one sensitivity value of at least one output measurement of a linear circuit, where the method includes receiving an input signal, identification of at least one output measurement, and circuit-element sensitivity values corresponding to the linear circuit; performing eigenvalue analysis of at least one linear circuit system matrix; computing adjoint eigenvectors for each of at least one output measurement; determining convolution eigenfunctions for the input signal; evaluating values and/or integrals of convolution eigenfunctions associated with each of at least one output measurement; and computing a weighted sum of products where the weights are based on the circuit-element sensitivity values to produce at least one sensitivity value of the output measurement. In another aspect of the invention, when at least one circuit-element sensitivity value is changed, repeating computing the weighted sum of products with different weights reflecting the change of at least one circuit-element sensitivity value to determine an updated sensitivity value of the output measurement. In another aspect of the invention, when the output measurement is changed but is based at the same node from the prior output measurement, repeating evaluating values and/or integrals of convolution eigenfunctions for the different output measurement, and computing weighted sum to determine the sensitivity value for the different output measurement. In another aspect of the invention, when the different output measurement includes a node different from the node of the prior output measurement, repeating computing adjoint eigenvectors for the different output measurement, evaluating values and/or integrals of convolution eigenfunctions and computing weighted sum steps to determine a second sensitivity value for the different output measurement. In another aspect of the invention, when the input signal is modified, repeating determining convolution eigenfunctions for the modified input signal, evaluating values and/or integrals of convolution eigenfunctions and computing weighted sum steps to determine the updated sensitivity value. In other aspects of the invention, the sensitivity value is selected from slew, delay, noise, and power.

According to one exemplary embodiment of the invention, the invention includes a method for determining at least one sensitivity value of at least one output measurement of a linear circuit, where the method includes receiving an input signal, identification of at least one output measurement, and circuit-element sensitivity values corresponding to the linear circuit; determining a reduced-order model of the linear circuit system matrix; computing at least one reduced-order linear circuit system matrix; computing reduced-order circuit-element sensitivity values corresponding to the reduced-order model; performing eigenvalue analysis of at least one reduced-order linear circuit system matrix; computing adjoint eigenvectors for each of at least one output measurement; determining convolution eigenfunctions for the input signal; evaluating values and/or integrals of convolution eigenfunction associated with each of at least one output measurement; and computing a weighted sum of products where the weights are based on the reduced-order circuit-element sensitivity values to produce at least one sensitivity value of the output measurement.

According to one exemplary embodiment of the invention, the invention includes a computer program product for determining a sensitivity value of an interconnect circuit, where the computer program product includes a computer readable medium; first program instruction means for receiving an input signal, identification of at least one output measurement, and circuit-element sensitivity values corresponding to the linear circuit; second program instruction means for performing eigenvalue analysis of at least one linear circuit system matrix; third program instruction means for computing adjoint eigenvectors for each of at least one output measurement; fourth program instruction means for determining convolution eigenfunctions for the input signal; fifth program instruction means for evaluating values and/or integrals of convolution eigenfunctions associated with each of at least one output measurement; and sixth program instruction means for computing a weighted sum of products where the weights are based on the circuit-element sensitivity values to produce at least one sensitivity value of the output measurement.

According to one exemplary embodiment of the invention, the invention includes a computer program product for determining a sensitivity value of an interconnect circuit, where the computer program product includes a computer readable medium; first program instruction means for receiving an input signal, identification of at least one output measurement, and circuit-element sensitivity values corresponding to the linear circuit; a second program instruction means for determining a reduced-order model of the linear circuit system matrix; a third program instruction means for computing at least one reduced-order linear circuit system matrix; a fourth program instruction means for computing reduced-order circuit-element sensitivity values corresponding to the reduced-order model; a fifth program instruction means for performing eigenvalue analysis of at least one reduced-order linear circuit system matrix; a sixth program instruction means for computing adjoint eigenvectors for each of at least one output measurement; a seventh program instruction means for determining convolution eigenfunctions for the input signal; a eighth program instruction means for evaluating values and/or integrals of convolution eigenfunction associated with each of at least one output measurement; and a ninth program instruction means for computing a weighted sum of products where the weights are based on the reduced-order circuit-element sensitivity values to produce at least one sensitivity value of the output measurement.

Given the following enabling description of the invention, particularly with respect to the drawings, the method and apparatus according to the invention should become evident to a person of ordinary skill in the art.

### IV. BRIEF DESCRIPTION OF THE DRAWINGS

The present invention is described with reference to the accompanying drawings, wherein:

FIG. 1 illustrates an exemplary measurement of noise.

FIG. 2 is a flow diagram of a method for calculating delay sensitivity in accordance with the present invention.

FIG. 3 is the flow diagram of FIG. 2 illustrating the incremental cost to change the sensitivity parameter in accordance with the present invention.

FIG. 4 is the flow diagram of FIG. 2 illustrating the incremental cost to change the output node in accordance with the present invention.

FIG. 5 is the flow diagram of FIG. 2 illustrating the incremental cost to compute the slew sensitivity in accordance with the present invention.

FIG. 6 is the flow diagram of FIG. 2 illustrating the incremental cost to change the circuit input in accordance with the present invention.

FIG. 7 is a schematic illustration of a sample circuit to which the method of the present invention can be applied.

FIG. 8 is a graphical representation of the variation of computer run time with respect to the number of sensitivity parameters and sensitivity functions for the method of the present invention and the previously known finite-difference method.

FIG. 9 is a graphical representation of the accuracy of the reduced order model version (order 6, order 12 and order 18) of the method of the present invention (MOR Modal Adjoint) compared to the exact version of the method of the present invention (Modal Adjoint).

FIG. 10 is a graphical representation of the temporal variation of the convolution eigenfunctions v, w, r, s and z for a sample circuit driven by an input waveform of the saturated ramp form typical of integrated circuit operation and illustrates the qualitative behavior of these eigenfunctions.

### V. DETAILED DESCRIPTION OF THE DRAWINGS

Initially, a summary of the relevant results from a typical adjoint approach to sensitivity analysis is provided and then, in accordance with a non-limiting exemplary embodiment of the present invention, an analytical modal technique is applied to adjoint sensitivity analysis for linear circuits. The modal adjoint technique is efficient for small to moderate sized circuits in its original form.

Because this exemplary embodiment deals mainly with the sensitivity analysis of an interconnect circuit, it is assumed that the response of the main functional circuit along with its design and environmental parameters at their nominal values has already been obtained. Those skilled in the art will understand how to obtain the response of the functional circuit and, thus, details of the analysis of the functional circuit are omitted here.

According to the invention it is desired to determine how the response of the functional circuit changes when each of the variable parameters takes on a value different from its nominal value. It should be noted that according to the exemplary embodiment discussed here, the analysis presented is for small-scale or infinitesimal sensitivity, not for large-scale changes in the variable parameters. These sensitivities, however, are, for the most part, valid for relatively large parameter fluctuations, depending on the linearity of the functional dependence.

For an interconnect circuit of interest, there are a number of different performance functions that are of concern. Typically, these performance functions involve the behavior of the output nodes of the interconnect circuit. For example, the most common functions are the delay and slew at each of the output nodes of the functional circuit. For purposes of this discussion, the “delay” time is the 50% crossing time, and of the “slew” or “transition” time is the difference between the 90% and 10% crossing times. One of ordinary skill in the art will appreciate that other crossing times are used in the field for “slew” time. Other performance functions include, for example, noise, which will be discussed later, and power, which based on this disclosure one of ordinary skill in the art can use the described methodology for power sensitivity.

Here, the i^{th} such function is denoted by Φᵢ. In general, the performance function depends on the values of a set of variable sensitivity parameters, p={p₁,p₂, . . . ,pₙ}. The objective is to compute the matrix of derivatives of all sensitivity functions with respect to all sensitivity parameters, ∂Φᵢ/∂pⱼ. In general, all of the performance functions of interest can be expressed as:

$$Φ ( p ) = {\int }_{0}^{T} d t φ ( x , \dot{x} , p , t ) \qquad ( 1 )$$

where the integral is determined over the time period of switching activity and φ is a function of the state vector x, its time derivative, the variable parameters p and possibly the time. The form of φ is determined by the particular sensitivity function of interest. In the case of a crossing time, i.e., the time at which a voltage signal crosses a particular value v_{c}, φ takes the form

φ(x,\dot{x},p,t)=te^{T}\dot{x}δ(e^{T}x−v_{c}) (2)

where e is a selection vector that indicates which node voltage is of interest.

There are a variety of methods that can be used to calculate the sensitivity of an electrical circuit. One relatively easy method comprises performing a finite-difference analysis in which each variable parameter is incrementally altered from its nominal value and the new response of the circuit is obtained using the same analysis method used to determine the nominal response. For example, circuit simulation, Elmore-delay, RICE, as well as other methods, can be employed. The partial derivative is approximated by ΔΦᵢ/Δpⱼ. While simple to implement, this approach requires one additional complete circuit analysis for each variable parameter, which imposes a high overhead for sensitivity computation.

Alternative methods to that which is discussed above rely on particular forms of circuit analysis, e.g., moment matching and computation of dominant poles and residues by model order reduction, and computed sensitivities of moments, poles and residues, as discussed, for example by R. W. Freund and P. Feldmann, “Small-signal circuit analysis and sensitivity computations with the PVL algorithm,” IEEE Transactions on Circuits and Systems II: Analog and Digital Signal Processing, Vol. 43/ 8, Aug. 1996, pp. 577-585, and J. H. Lee, X. Huang and R. A. Rohrer, “Pole and zero sensitivity calculation in Asymptotic Waveform Evaluation,” IEEE Transactions on Computer-Aided Design of Integrated Circuits and Systems, Vol. 11/ 5, May 1992, pp. 586-597, the contents of which are incorporated herein by reference for all that they teach. These sensitivity values are then used further to compute the quantities of interest.

Finally, general methods of sensitivity analysis include the direct and adjoint methods discussed above. In the context of statistical timing, it is expected that the number of sensitivity functions will be relatively small, e.g., one or two functions per output node, while the number of sensitivity parameters can be quite large, e.g., a total of more than ten, and increasing in number as the variability of the modern semiconductor process increases. Accordingly, the present embodiment focuses on adapting the adjoint method to the interconnect analysis problem.

Consider an interconnect circuit whose time evolution is described in pure-nodal form as:

C\dot{x}(t)+Gx(t)=bu(t) (3)

where C and G are the capacitance and conductance matrices (or linear circuit system matrices), respectively, u(t) is the input waveform, and b is a selection vector that indicates where the circuit is being driven. In pure nodal formulation, both C and G are symmetric matrices. The C and G matrices are also positive definite if each node is connected to ground by a non-zero capacitance, which is an assumption for convenience of this discussion. However, those of skill in the art should know that the analysis can easily be extended to the alternative case. In the case where one or more nodes of the circuit are not connected to ground by a non-zero capacitance, the capacitance matrix C becomes singular and can be decomposed into a null space and its complement. The degrees of freedom belonging to the null space are purely algebraic—they are determined completely by the degrees of freedom that belong to the non-singular part of C. By eliminating the algebraic degrees of freedom from Eq. (3), one obtains a smaller version of Eq. (3) with a non-singular version of c, to which one may apply the analysis described in this description.

The fundamental result of the adjoint sensitivity method is that the sensitivity can be written as:

$$\frac{\partial Φ ( p )}{\partial p} = {\int }_{0}^{T} d t [ \frac{\partial φ}{\partial p} + {\hat{x}}^{T} ( t ) \{ \frac{\partial C}{\partial p} \dot{x} + \frac{\partial G}{\partial p} x - \frac{\partial ( bu )}{\partial p} \} ] \qquad ( 4 )$$

where \hat{x}(t) is the adjoint waveform, the solution of the adjoint circuit equation:

$$- C \dot{\hat{x}} ( t ) + G \hat{x} ( t ) = - \frac{\partial {φ}^{T}}{\partial x} + \frac{\partial }{\partial t} {( \frac{\partial φ}{\partial \dot{x}} )}^{T} \qquad ( 5 )$$

In the case of a crossing time, the adjoint circuit equation takes the form:

$$- C \dot{\hat{x}} ( t ) + G \hat{x} ( t ) = \frac{e}{{e}^{T} \dot{x} ( {t}_{c} )} δ ( t - {t}_{c} ) \qquad ( 6 )$$

where t_{c} is the time at which the node voltage of interest crosses the target value v_{c}. Of note is that the adjoint circuit is solved backwards in time, with a homogeneous final condition \hat{x}(T)=0.

For simplicity, computation of delay sensitivity is first considered. Thereafter, the results are extended to slew sensitivity. First, both the nominal and adjoint circuits are formally solved analytically, in terms of a generalized eigenvalue analysis of the matrices C and G. That is, the solution to the problem is obtained as follows:

CV=GVA (7)

where V is a n×n matrix of the same size as C and G, and Λ is a diagonal matrix whose diagonal entries λ_{α} are the n eigenvalues of the system. The eigenvalues are positive definite, have dimensions of time, and their inverses are denoted as f_{α}=λ_{α}⁻¹; and f_{α} can be thought of as a frequency. For small systems, such an analysis is not unreasonably expensive. However, for larger systems (systems that depending upon the structure would be in excess of at least 20 nodes), a model-order reduction scheme is used. Larger systems compared to smaller systems as a measure is dependent on the nature of the circuit and the frequencies and types of signals present in the circuit.

The solution to the nominal circuit is written as follows:

$$x ( t ) = {\sum }_{α}^{ } {x}_{α} {v}_{α} ( t ) \qquad ( 8 )$$

where;

$$\begin{matrix}{v}_{α} ( t ) ≡ {f}_{α} {\int }_{0}^{t} d {t}^{′} {e}^{- {f}_{α} ( t - {t}^{′} )} u ( {t}^{′} ) & ( 9 ) \\ {x}_{α} ≡ {VP}_{α} {V}^{T} b & ( 10 )\end{matrix}$$

Here, v_{α} is the convolution of the input waveform with an exponential response. For input waveforms of step, ramp or exponential form, this convolution can be done analytically and involves just a few simple terms. The matrix P_{α} is the projection operator onto the α^{th} eigenspace. That is, a n×n matrix with a single “1” in the α^{th} diagonal entry. The solution of the adjoint circuit equation is expressed formally as:

$$\hat{x} ( t ) = {\sum }_{α}^{ } {\hat{x}}_{α} {β}_{c} {f}_{α} {e}^{- {f}_{α} ( {t}_{c} - t )} θ ( {t}_{c} - t ) \qquad ( 11 )$$

where:

$$\begin{matrix}{β}_{c} ≡ \frac{1}{{e}^{T} \dot{x} ( {t}_{c} )} & ( 12 ) \\ {\hat{x}}_{α} ≡ {VP}_{α} {V}^{T} e & ( 13 )\end{matrix}$$

and θ(t) is the unit step function.

For the case of delay sensitivity, the function φ is independent of the parameters. With expressions for the nominal and adjoint waveforms obtained, it is possible to substitute them into the expression for the sensitivity in Eq. (4), above, to obtain:

$$\frac{\partial Φ}{\partial p} = {\int }_{0}^{T} d t [ \{ {\sum }_{α}^{ } {\hat{x}}_{α}^{T} {β}_{c} {f}_{α} {e}^{- {f}_{α} ( {t}_{c} - t )} θ ( {t}_{c} - t ) \} \times \{ \frac{\partial C}{\partial p} {\sum }_{β}^{ } {x}_{β} {r}_{β} ( t ) + \frac{\partial G}{\partial p} {\sum }_{β}^{ } {x}_{β} {v}_{β} ( t ) - \frac{\partial ( bu )}{\partial p} \} ] \qquad ( 14 )$$

where v_{α}(t) is defined in Eq. (9), and r_{α}(t) is defined in Eq. (44). By separating the matrix-related terms from the time-dependent terms, and carrying out the time integrals in terms of the time-domain eigenfunctions, discussed below, the sensitivity result is obtained as follows:

$$\frac{\partial Φ}{\partial p} = {\sum }_{α} [ ( {\hat{x}}_{α}^{T} \frac{\partial G}{\partial p} {x}_{α} ) {W}_{α} + ( {\hat{x}}_{α}^{T} \frac{\partial G}{\partial p} {a}_{α} ) {V}_{α} + ( {\hat{a}}_{α}^{T} \frac{\partial G}{\partial p} {x}_{α} ) {V}_{α} + ( {\hat{x}}_{α}^{T} \frac{\partial C}{\partial p} {x}_{α} ) {S}_{α} + ( {\hat{x}}_{α}^{T} \frac{\partial C}{\partial p} {a}_{α} ) {R}_{α} + ( {\hat{a}}_{α}^{T} \frac{\partial C}{\partial p} {x}_{α} ) {R}_{α} - ( {\hat{x}}_{α}^{T} \frac{\partial b}{\partial p} ) {V}_{α} - ( {x}_{α}^{T} b ) {Z}_{α} ] \qquad ( 15 )$$

with the following definitions:

$$\begin{matrix}{a}_{α} ≡ {\sum }_{β \neq α} \frac{{f}_{β}}{{f}_{β} - {f}_{α}} {x}_{β} & ( 16 ) \\ {\hat{a}}_{α} ≡ {\sum }_{β \neq α} \frac{{f}_{β}}{{f}_{β} - {f}_{α}} {\hat{x}}_{β} & ( 17 ) \\ {V}_{α} ≡ {β}_{c} {v}_{α} ( {t}_{c} ) & ( 18 ) \\ {W}_{α} ≡ {β}_{c} {w}_{α} ( {t}_{c} ) & ( 19 ) \\ {R}_{α} ≡ {β}_{c} {r}_{α} ( {t}_{c} ) & ( 20 ) \\ {S}_{α} ≡ {β}_{c} {s}_{α} ( {t}_{c} ) & ( 21 ) \\ {Z}_{α} ≡ {β}_{c} {z}_{α} ( {t}_{c} ) & ( 22 )\end{matrix}$$

Eq. (15) gives the result for the sensitivity of circuit performance Φ with respect to sensitivity parameter p in terms of a number of different constituent quantities—the vectors x_{α},a_{α},\hat{x}_{α},â_{α} and the numbers V_{α},W_{α},R_{α},S_{α},Z_{α}. Eqs. (16-22) define those constituent quantities that have not previously been defined. Eqs. (16) and (17) define the vectors a_{α},â_{α} in terms of the vectors x_{α},\hat{x}_{α} of the original and adjoint circuits. Eqs. (18-22) define the quantities V_{α},W_{α},R_{α},S_{α},Z_{α}, which represent different measures of the behavior of the input waveform at the time of interest, in terms of the convolution waveforms v_{α}(t_{c}),w_{α}(t_{c}),r_{α}(t_{c}),s_{α}(t_{c}),z_{α}(t_{c}) evaluated at the crossing time(s).

The expression for the sensitivity provided by Eq. (15) represents a main concept. More particularly, the expression in Eq. (15) comprises a number of very desirable features. First, the circuit-element sensitivity matrices ∂C/∂p, ∂G/∂p and ∂b/∂p are typically very sparse and for many choices of the sensitivity parameter p one or more may vanish altogether. It should be noted that in a pure nodal formulation, the vector b typically depends on circuit elements and, therefore, on the parameters that cause those circuit elements to vary. Also, it is relatively trivial to determine whether or not a particular term in Eq. (15) contributes to the overall sensitivity before doing any computational work. In addition, using standard sparse matrix techniques, the matrix-vector products and matrix-element computations that do contribute to the sensitivity can be performed quite efficiently. Also, it is noted that the time-domain eigenfunctions that appear in Eq. (15) need only be evaluated at the nominal crossing time.

Furthermore, the expression for sensitivity provided in Eq. (15) lends itself easily to incremental analysis as will be discussed in greater detail later. For instance, consider the situation where it is desired to determine the sensitivity of the slew at the same node for which Eq. (15) gives the delay sensitivity. The only quantities in Eq. (15) that must be changed in this situation are the quantities V_{α}, W_{α}, R_{α}, S_{α} and Z_{α}. In the case of slew sensitivity for a rising transition, such as for a step or ramp input signal, these quantities are redefined as:

V_{α}≡β₂v_{α}(t₂)−β₁v_{α}(t₁)

W_{α}≡β₂w_{α}(t₂)−β₁w_{α}(t₁)

R_{α}≡β₂r_{α}(t₂)−β₁r_{α}(t₁)

S_{α}≡β₂s_{α}(t₂)−β₁s_{α}(t₁)

Z_{α}≡β₂z_{α}(t₂)−β₁z_{α}(t₁) (23)

where t₁ and t₂ are the 10% and 90% crossing times of the nominal waveform, and βᵢ=1/e^{T}\dot{x}(tᵢ).

This method can also be extended to treat the sensitivity of noise coupling using nearly identical computational mechanics and ingredients as those described above for the delay and slew. Described below is how the method is useable with noise coupling sensitivity.

Coupling noise occurs when a signal line (known as the aggressor) switches from low to high voltage (or vice versa) in close proximity to a second signal line (known as the victim). Because of the close physical proximity of the two signal lines and the capacitive coupling between them, there is created on the victim signal line a voltage pulse of some magnitude and duration. If the magnitude and duration of the pulse are sufficiently large, the transistor at the end of the victim signal line may switch from one state to another, even though the input to the victim signal line has not changed.

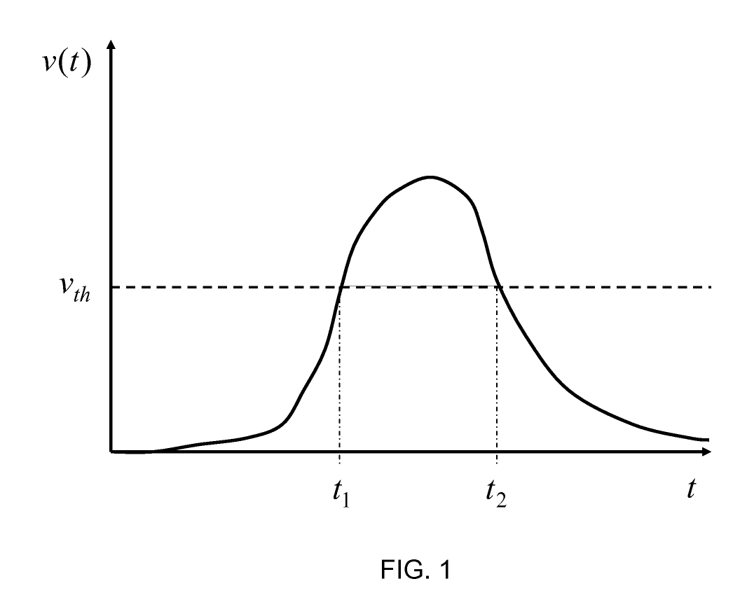

The standard measure of the severity of coupling noise is taken as the area between of the voltage at the terminus of the victim signal line and a threshold voltage, vₜₕ, that represents the voltage at which false switching could occur. This measure of noise is illustrated in FIG. 1 as the shaded area between v(t) and vₜₕ.

The noise function can be expressed as:

$$\begin{matrix}Φ ( p ) = {\int }_{{t}_{1}}^{{t}_{2}} d t [ v ( t , p ) - {v}_{th} ] & ( 24 ) \\ Φ ( p ) = {\int }_{0}^{T} d t Θ ( {e}^{T} x ( t , p ) - {v}_{th} ) & ( 25 )\end{matrix}$$

Applying the techniques of adjoint sensitivity to Eq. (25), one obtains the adjoint circuit equation

$$- C \dot{\hat{x}} ( t ) + G \hat{x} ( t ) = - e \{ θ ( t - {t}_{1} ) - θ ( t - {t}_{2} ) \} \qquad ( 26 )$$

The solution to the adjoint circuit equation is:

$$\hat{x} ( t ) = {\sum }_{α} {\hat{x}}_{α} \{ {h}_{α} ( {t}_{1} - t ) - {h}_{α} ( {t}_{2} - t ) \} \qquad ( 27 )$$

where the function h_{α}(t) is defined as:

h_{α}(t)≡└1−e^{-f}^{_{α}}^{t}┘θ(t) (28)

Substituting the result in Eq. (27) into the Eq. (4), one obtains the solution to the noise sensitivity:

$$\frac{\partial Φ}{\partial p} = - ( {\hat{X}}^{T} \frac{\partial G}{\partial p} X ) U - ( {\hat{X}}^{T} \frac{\partial C}{\partial p} X ) \overline{U} + ( {\hat{X}}^{T} b ) {U}^{′} + ( {\hat{X}}^{T} \frac{\partial b}{\partial p} ) U + {\sum }_{α} [ ( {\hat{x}}_{α}^{T} \frac{\partial G}{\partial p} {x}_{α} ) ( {\overline{V}}_{α} + {\overline{W}}_{α} ) + ( {\hat{x}}_{α}^{T} \frac{\partial G}{\partial p} {a}_{α} ) {\overline{V}}_{α} + ( {\hat{a}}_{α}^{T} \frac{\partial G}{\partial p} {x}_{α} ) {\overline{V}}_{α} + ( {\hat{x}}_{α}^{T} \frac{\partial C}{\partial p} {x}_{α} ) ( {\overline{R}}_{α} + {\overline{S}}_{α} ) + ( {\hat{x}}_{α}^{T} \frac{\partial C}{\partial p} {a}_{α} ) {\overline{R}}_{α} + ( {\hat{a}}_{α}^{T} \frac{\partial C}{\partial p} {x}_{α} ) {\overline{R}}_{α} - ( {\hat{x}}_{α}^{T} \frac{\partial b}{\partial p} ) {\overline{V}}_{α} ] \qquad ( 29 )$$

With the following definitions of various quantities used in Eq. (29):

$$\begin{matrix}X ≡ {\sum }_{α} {x}_{α} & ( 30 ) \\ \hat{X} ≡ {\sum }_{α} {\hat{x}}_{α} & ( 31 ) \\ {\overline{V}}_{α} ≡ {λ}_{α} [ {w}_{α} ( {t}_{2} ) - {w}_{α} ( {t}_{1} ) ] & ( 32 ) \\ {\overline{W}}_{α} ≡ {λ}_{α} [ {w}_{α} ( {t}_{2} ) - {w}_{α} ( {t}_{1} ) ] & ( 33 ) \\ {\overline{R}}_{α} ≡ {λ}_{α} [ {r}_{α} ( {t}_{2} ) - {r}_{α} ( {t}_{1} ) ] & ( 34 ) \\ {\overline{S}}_{α} ≡ {λ}_{α} [ {s}_{α} ( {t}_{2} ) - {s}_{α} ( {t}_{1} ) ] & ( 35 ) \\ U ≡ {\int }_{{t}_{1}}^{{t}_{2}} d t u ( t ) & ( 36 ) \\ {U}^{′} ≡ {\int }_{{t}_{1}}^{{t}_{2}} d t \frac{\partial u ( t )}{\partial p} & ( 37 ) \\ \overline{U} ≡ u ( {t}_{2} ) - u ( {t}_{1} ) & ( 38 )\end{matrix}$$

Eq. (29) gives the result for the sensitivity of circuit performance Φ with respect to sensitivity parameter p in terms of a number of different constituent quantities—the vectors X and \hat{X} and the numbers V̅_{α}, W̅_{α}, R̅_{α}, S̅_{α}, Z̅_{α}. Eqs. (30-38) define those constituent quantities that have not previously been defined. Eqs. (30) and (31) define the vectors X,\hat{X} in terms of the vectors x_{α}, \hat{x} of the original and adjoint circuits. Eqs. (32-36) define the quantities V̅_{α}, W̅_{α}, R̅_{α}, S̅_{α}, Z̅_{α}, which represent different measures of the behavior of the input waveform in terms of the convolution waveforms v_{α}(t_{c}),w_{α}(t_{c}), r_{α}(t_{c}),s_{α}(t_{c}),z_{α}(t_{c}) evaluated at different crossing times. U and U′ represent input signal integrals.

All of the features of incrementality that were present in the case of delay and slew sensitivity are also present here in the case of noise sensitivity.

Next is a description of how the results of the sensitivity calculation performed in accordance with the embodiment above are efficiently re-formulated for larger circuits in accordance with the present invention, for example, using various methods of model-order reduction.

For circuits of modest size, the sensitivity calculation described above is sufficient. A circuit of modest size in the context of this method is one for which the cost of performing an eigenanalysis of the system is acceptable. The size of the circuit, as specified by the dimension of the state vector, should not exceed 15-20. For many circuits, the dimension of the state vector is approximately equal to the number of nodes in the circuit. So in practice, one could say that a circuit of moderate size is one of 15-20 nodes or fewer. However, as the size of the circuit increases, the cost of the generalized eigenanalysis begins to grow rapidly. Under these circumstances, in accordance with a further embodiment it becomes necessary to combine the modal analysis described in the embodiment above with a reduced-order model analysis of the nominal circuit.

According to this embodiment, a Krylov subspace is generated by iteratively applying the matrix G⁻¹C. to the vector b. Those having skill in the art would understand that iterative techniques, such as the Arnoldi iteration and the Lanczos algorithm can be used. A matrix U is, thus, generated that maps a state vector z(t) in a much smaller state space to the original state vector x(t):

x(t)≅Uz(t). (39)

Therefore, according to this embodiment, with this relationship between x(t) and z(t), the original circuit equations can be reformulated for the nominal and adjoint circuits in terms of their reduced-order model companions:

$$\begin{matrix}\tilde{C} \dot{z} ( t ) + \tilde{G} z ( t ) = \tilde{b} u ( t ) & ( 40 ) \\ - \tilde{C} \dot{\hat{z}} ( t ) + \tilde{G} \hat{z} ( t ) = \frac{\tilde{e}}{{\tilde{e}}^{T} \dot{z} ( {t}_{c} )} δ ( t - {t}_{c} ) & ( 41 )\end{matrix}$$

where the tilde quantities are defined as:

\tilde{C}≡U^{T}CU

\tilde{G}≡U^{T}GU

\tilde{b}≡U^{T}b

\tilde{e}≡U^{T}e

and it is assumed that the node of interest is a port in the reduced-order network.

The model-order reduction techniques according to the present invention preserve the symmetric positive-definite properties of the conductance and capacitance matrices and permit the modal adjoint technique to be applied to the reduced-order model of the nominal circuit and its adjoint companion. When combined with the adjoint sensitivity result in Eq. (4), above, a result is obtained that is analogous to Eq. (15), except that the generalized eigenanalysis is performed on \tilde{C} and \tilde{G}, and the circuit element sensitivity matrices are transformed as follows:

$$\frac{\partial C}{\partial p} -> {U}^{T} \frac{\partial C}{\partial p} U$$

$$\frac{\partial G}{\partial p} -> {U}^{T} \frac{\partial G}{\partial p} U$$

$$\frac{\partial b}{\partial p} -> {U}^{T} \frac{\partial b}{\partial p}$$

It is important to note that unlike other methods of combining sensitivity analysis with model-order reduction, the method according to the present invention does not require the matrix U to be differentiated with respect to the sensitivity parameters, even though U is indeed a function of the parameters. According to the present invention, one need only transform the original circuit-element sensitivities as shown above.

According to a further embodiment it is demonstrated that the modal adjoint technique discussed above lends itself to incremental implementation where many parts of the computation can be re-used when one aspect of the sensitivity problem is changed.

One of the benefits arising from the modal adjoint sensitivity analysis described above in accordance with one embodiment is that the computation of a sensitivity value involves the evaluation of a handful of terms each of which is, to a certain extent, independent of many details of the sensitivity problem.

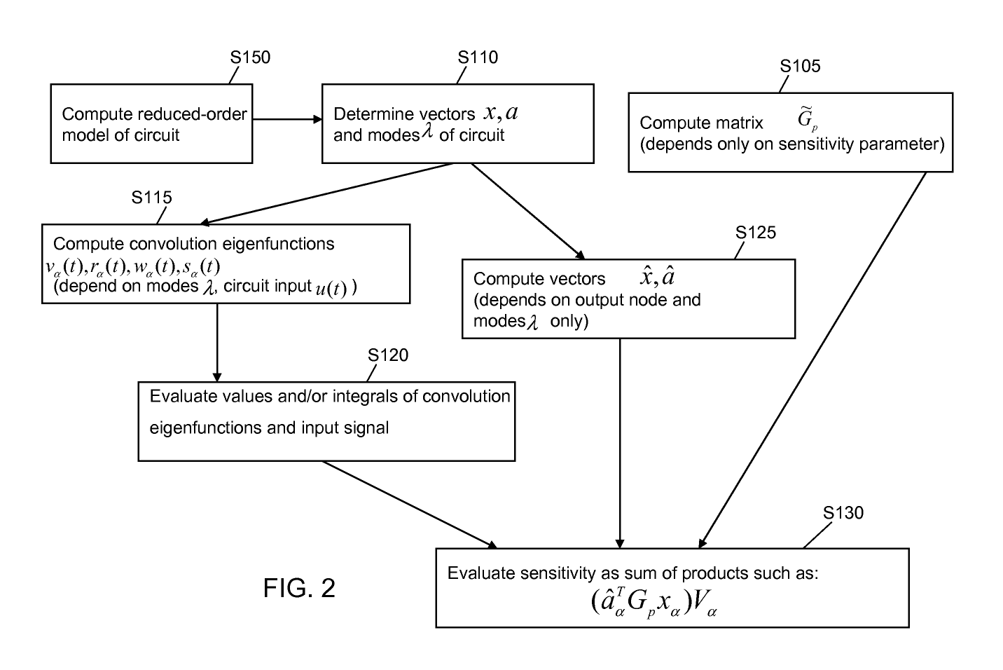

As shown in FIG. 2, the results expressed in Eqs. (15) and (29) break down into a series of computational steps where the starting information includes an input signal, identification of an output measurement including a node and sensitivity value, and circuit-element sensitivity values (or sensitivity parameters). As such, the starting information in at least one exemplary embodiment is received. The computational steps are as follows:
1) Obtain the circuit-element sensitivity matrices (these quantities depend on the sensitivity parameters (or circuit-element sensitivity values)), S105.
2) Perform generalized eigenanalysis to determine x_{α}, a_{α} and λ_{α}, (these quantities depend only on the topology and element values of the nominal (or linear) circuit, and not on the sensitivity functions (sensitivity value of the output measurement) or sensitivity parameters), S110.
3) Determine the time-domain eigenfunctions v_{α}, w_{α}, r_{α}, s_{α} and z_{α} (these quantities depend only on the input waveform and the eigenvalues λ_{α}, but not on the sensitivity function or parameters), S115. In the case of delay and sensitivity, the time-domain eigenfunctions provide a value. While in the case of power, the time-domain eigenfunctions provide an integral.
4) Evaluate the time-domain eigenfunctions V_{α}, W_{α}, R_{α}, S_{α} and Z_{α} at the crossing time(s) for the sensitivity function such as delay and slew (these quantities depend on the sensitivity function being analyzed as well as the input waveform), S120. The time-domain eigenfunctions are evaluated over an integral when the sensitivity function is for power.
5) Compute the adjoint vectors \hat{x}_{α} and â_{α} (these quantities depend on the node at which the sensitivity function is defined, but not on what the function is, nor on the sensitivity parameters or input waveform), S125.
6) Combine results from Steps S110-S125 to compute the final result as per Eq.

(15) or (29), S130. The weights on which the sensitivity value for the output measurement is provided are equivalent to the circuit-element sensitivity values.

As shown in FIG. 2, initially a reduced-order model of the circuit being analyzed is optionally computed, S150. This step is optional, as discussed above, because for certain, e.g., smaller sized, circuits it is not necessary to use the reduced-order model and the original circuit can be used. The reduced-order circuit-element sensitivity values and the circuit-element matrices are determined for the reduced-order model of the circuit.

With the sequence of computational steps outlined above, the incrementality of the modal adjoint algorithm can be described. If sensitivity analysis has already been performed and it is desired to change one aspect of the sensitivity problem, Table (1) below illustrates which of the computational steps will be redone.

TABLE 1

| Changed aspect: | Must redo steps: |
|---|---|
| Input waveform | S115, S120 |
| Sensitivity parameter (or | S105 |
| circuit-element sensitivity | |
| value) p | |
| Sensitivity node of the | S120, S125 |
| output measurement | |
| Sensitivity function at the | S120 |
| same node | |

Table 1 illustrates the incremental nature of modal adjoint sensitivity analysis. In addition to the steps listed in Table 1, above, one of skill in art would know that Step S130 from the list of computational steps listed above also will be performed if any of the aspects are changed.

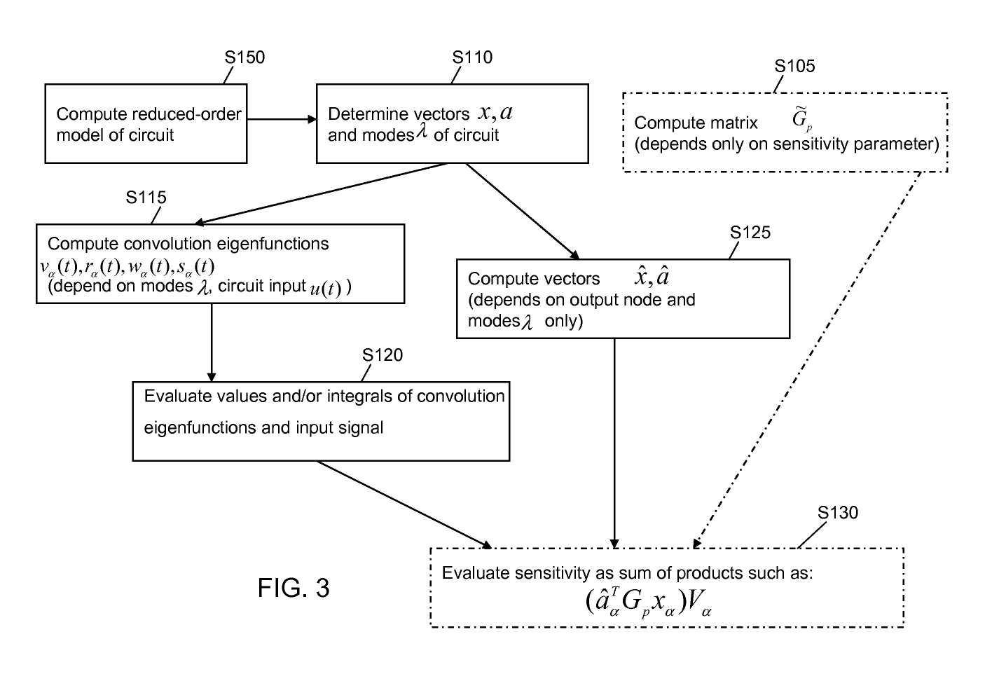

FIGS. 3-6 illustrate, in flow diagram form, the computational steps that must be redone when each of the aspects listed in Table 1 are changed. In particular, the steps that must be redone are shown as the dash-dot boxes. For instance, in FIG. 3 it is shown that when the sensitivity parameter changes, Steps S105 and S130 from the process flow above need only be redone.

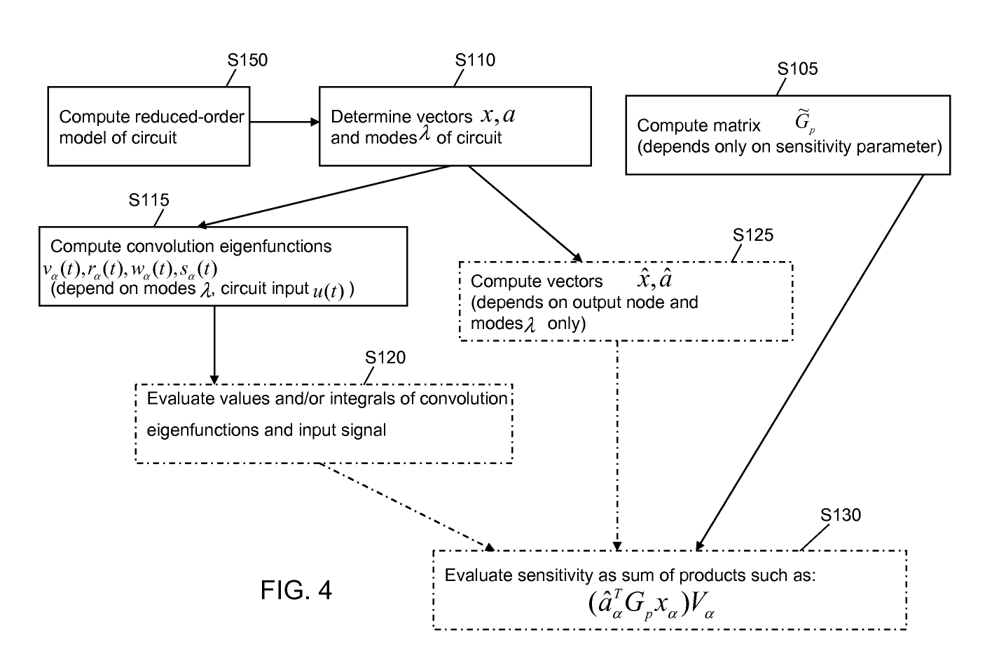

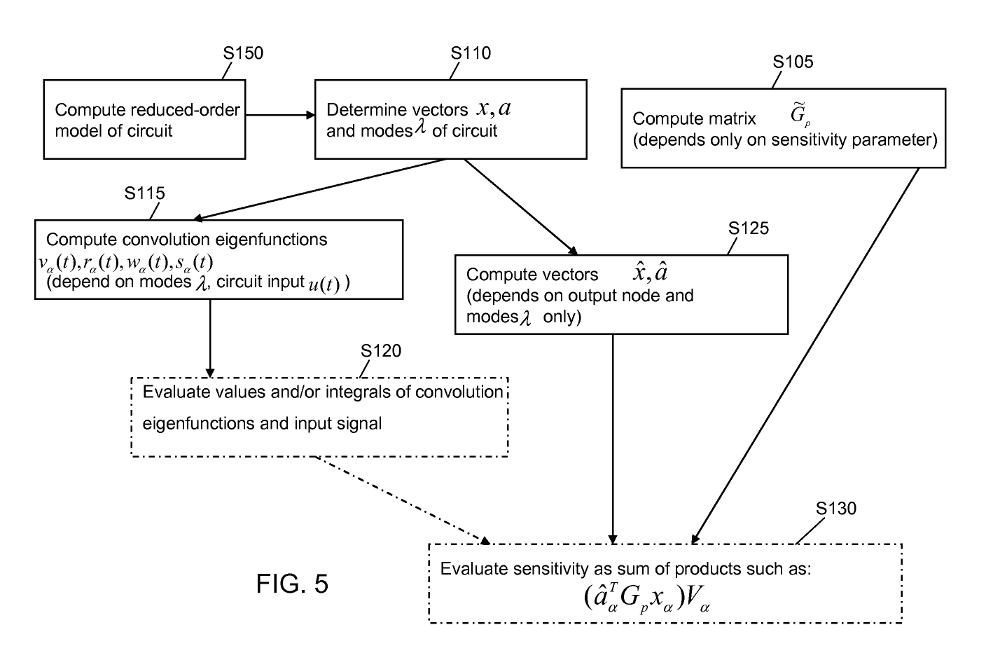

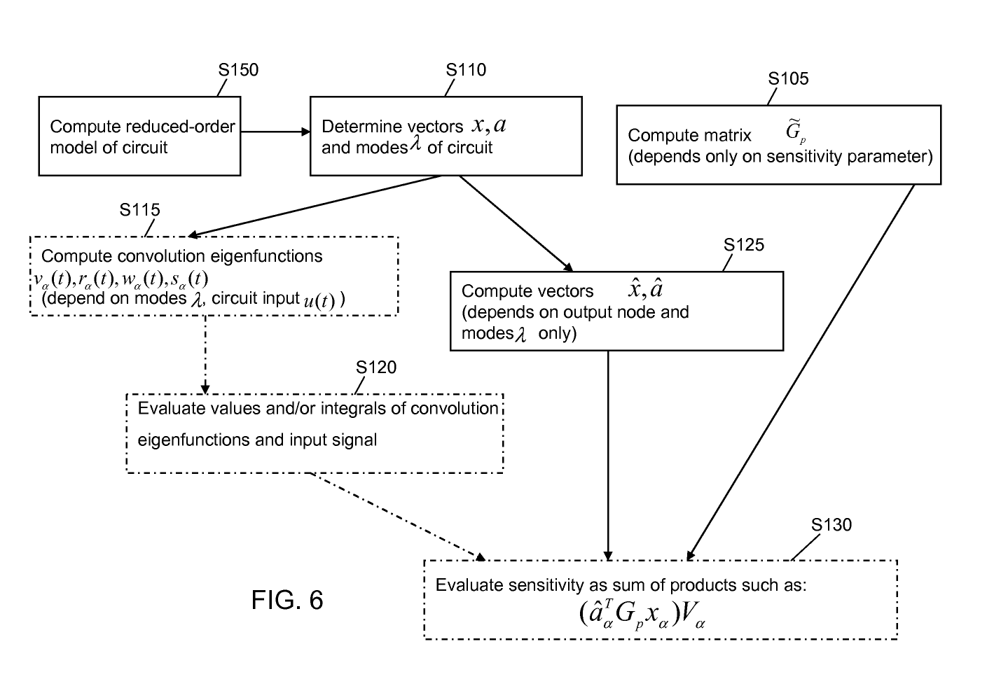

Further, in FIG. 4 it is illustrated that when the sensitivity, or output, node is changed, it is only necessary to redo Steps S120, S125 and S130 from the process flow disclosed above. In FIG. 5 it is shown that when the node does not change, but it is desired to compute another sensitivity, only Steps S120 and S130 need to be redone. Lastly, as shown in FIG. 6, when the circuit input waveform is changed, it is necessary to redo Steps S115, S120 and S130 to update the sensitivity value. Thus, as demonstrated in FIGS. 3-6, in accordance with the present invention, it is not necessary to repeat all Steps of the sensitivity analysis when aspects of the analysis change.

The incremental nature of the sensitivity algorithm discussed above provides an excellent advantage with respect to incremental static timing analysis tools. For example, a single metal interconnect line within a circuit may travel through multiple wiring levels and therefore its resistance and capacitance will vary with the width and thickness of multiple metal levels. According to the invention, to compute the sensitivity of circuit performance with respect to width and thickness variations on each of the metal levels, only Step S105 needs to be repeated for each parameter. Similarly, because static timers typically perform both early and late mode timing analysis where only the input slew to the interconnect is different, once the sensitivity of early mode timing is computed with respect to one sensitivity parameter, obtaining the sensitivity of late mode timing requires only Steps S115 and S120 to be repeated.

Next, results for a modal adjoint technique for an example circuit in accordance with the invention are discussed and a comparison of the computation time and accuracy with those of a finite-difference approach is provided.

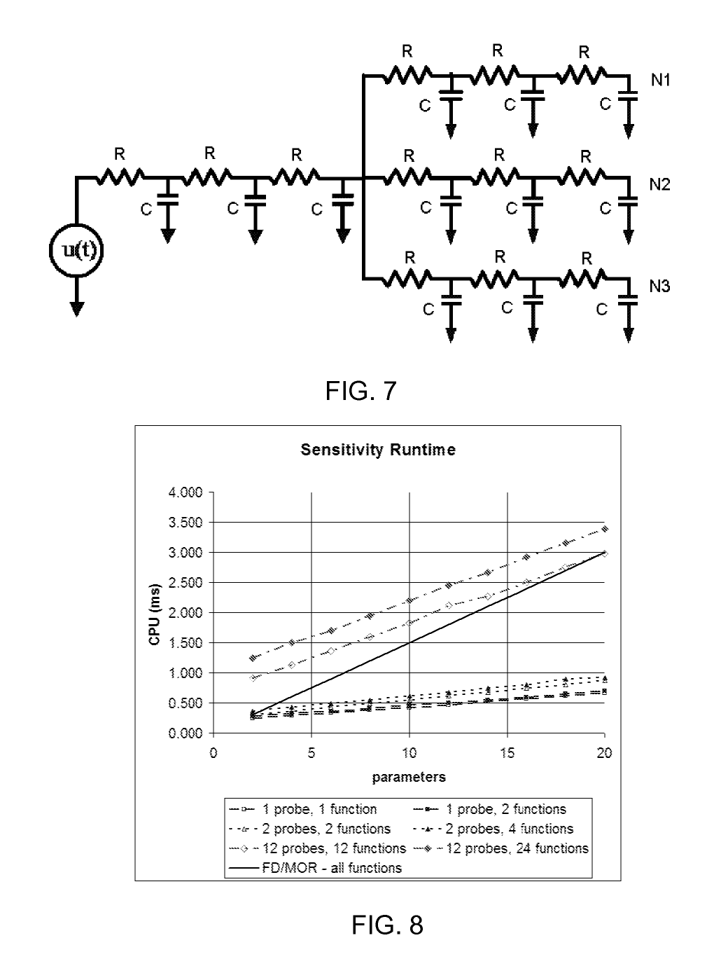

More particularly, the technique described above with respect to an embodiment of the invention is applied to the simple interconnect circuit shown in FIG. 7. As discussed below, the sensitivity values obtained from Eq. (15) are compared with finite-difference results obtained from a reduced-order model analysis.

Referring to the circuit of FIG. 7, the circuit is a model of an interconnect network with a fanout of three being driven by a ramp input (u(t)). The circuit consists of 12 resistors (R) and 12 capacitors (C), each of which is treated as an independent circuit-element sensitivity value (or sensitivity parameter) in accordance with this embodiment. Therefore, for the circuit of FIG. 7, up to 24 circuit-element sensitivity values are present.

For a typical static timing analysis application, the sensitivity functions (or sensitivity values of the output measurement(s)) of interest for the circuit of FIG. 7 would be the delay and slew at each of the three output nodes (N1-N3). For purposes of illustrating the performance of the modal adjoint algorithm, delay and slew are considered at all 12 non-trivial nodes of the circuit as possible sensitivity functions. That is, up to 24 sensitivity functions are considered.

In FIG. 8 computation times for the modal sensitivity analysis as discussed above, with respect to the circuit of FIG. 7, are compared to a finite-difference/model-order reduction (FD/MOR) analysis according to current methods. The computation time of the modal adjoint algorithm is shown as a function of the number of sensitivity functions and sensitivity parameters. The FD approach considered with respect to FIG. 8 consisted of changing, in sequence, each circuit element by an amount proportional to 0.1% of its nominal value and repeating the crossing times that determine the delays and slews of the circuit. As illustrated, the cost of the finite-difference technique is linear in the number of sensitivity parameters. The modal sensitivity analysis increases slowly with the number of sensitivity parameters and is much more efficient than the FD/MOR approach if the number of sensitivity functions is small. FIG. 8 illustrates that the method of the present invention is significantly more efficient than the finite-difference method when the number of sensitivity parameters is greater than the number of sensitivity functions.

The computation cost of a single sensitivity function using the modal analysis illustrated in FIG. 8 for the sample circuit shown in FIG. 7 rises linearly but very slowly with respect to the number of sensitivity parameters. The larger the number of sensitivity parameters, the more advantageous the modal analysis becomes compared to finite-difference. As demonstrated, the incremental cost of computing the slew sensitivity at the same node is very low.

When sensitivity functions from a second node are added to the problem, the cost of the modal analysis is increased very slightly, but the method remains more efficient than a finite-difference analysis. Only when the number of sensitivity functions becomes comparable to the number of sensitivity parameters does the method become less efficient than a finite-difference approach. More specifically, in this case, the direct method would be more efficient.

In order to determine the accuracy of the modal analysis, the results of the sensitivity results for the circuit of FIG. 7 are compared with those of the FD/MOR approach. Referring to Table 2, below, for each sensitivity parameter, the top value provided for the delay and slew sensitivities is the result of the modal adjoint analysis in Eq. (15), and the bottom value is the finite-difference result. The delay and slew sensitivities are computed for the output node labeled node N1 in the circuit of FIG. 7. As shown, the difference between the two methods is relatively small.

TABLE 2

| Sensitivity | Delay | Slew |
|---|---|---|
| Parameter | Sensitivity | Sensitivity |
| g₁ | −1.345558e+01 | −3.894700e+01 |
| | −1.344092e+01 | −3.890337e+01 |
| g₂ | −1.431816e+01 | −4.367039e+01 |
| | −1.430105e+01 | −4.361758e+01 |
| g₃ | −1.539773e+01 | −4.578844e+01 |
| | −1.537785e+01 | −4.572817e+01 |
| g₄ | −4.695538e+00 | −4.753304e+00 |
| | −4.690363e+00 | −4.747988e+00 |
| g₅ | −3.693167e+00 | −2.865586e+00 |
| | −3.688829e+00 | −2.862009e+00 |
| C₁ | 1.022272e+00 | 7.680572e−01 |
| | 1.022267e+00 | 7.680681e−01 |
| C₂ | 1.907716e+00 | 3.096345e+00 |
| | 1.907682e+00 | 3.096273e+00 |
| C₃ | 2.623638e+00 | 7.034289e+00 |
| | 2.623568e+00 | 7.033792e+00 |
| C₄ | 3.595508e+00 | 8.566894e+00 |
| | 3.595368e+00 | 8.566100e+00 |
| C₅ | 4.781391e+00 | 1.011941e+01 |
| | 4.781335e+00 | 1.011843e+01 |

According to an even further embodiment, the effectiveness and accuracy of the method in accordance with the invention is demonstrated for larger circuits. In particular, the reduced-order model version of modal adjoint sensitivity is applied to a sample circuit containing 314 capacitors and 152 resistors. Both delay and slew sensitivities are computed with respect to the circuit elements at one selected output node.

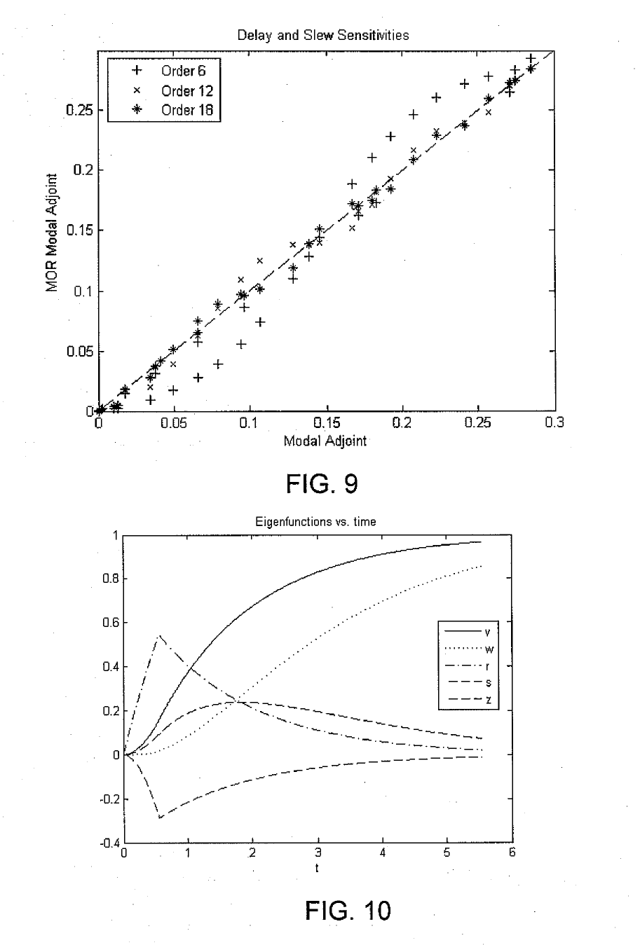

Specifically, referring to FIG. 9, a plot is shown of the results of MOR modal analysis versus the exact modal analysis for MOR orders 6, 12 and 18. The reduced-order model was generated using a band Arnoldi approach. FIG. 9 compares the results of an approximate calculation of sensitivities (MOR Modal Adjoint) with an exact calculation (Modal Adjoint). The approximate calculations are based on reduced order models of three different levels of accuracy: order 6 (less accurate), order 12, and order 18 (more accurate). Each plotted point has a y-coordinate given by the approximate result for a given order, while the x-coordinate is given by the exact result. Perfect agreement between the approximate and exact result would place the plotted point on the dashed diagonal line x=y. Thus, the distance of the plotted point from the dashed diagonal line is a measure of the inaccuracy (or error) of the approximate result obtained for the order model level using an exemplary embodiment of the invention. As one can see, the order 6 points (+) are farthest from the diagonal line and therefore the least accurate of the three different approximate calculations, while the order 18 points (*) are closest to the diagonal line are therefore the most accurate of the three. The order 12 points (x) are in between. For sensitivity analysis, it appears that a somewhat higher order reduced-order model (for example, order 18) is required to get acceptable accuracy than is required for timing analysis. As in most engineering problems, acceptable accuracy means to within a few percent of the exact result and depends upon the nature of the circuit and the signals present in the circuit. The process of generating a reduced order model is one of successively including more and more of the modes of the circuit's operation (beginning with the most significant modes and then including successively less important modes). With each higher order of the reduced order model, one more mode of the circuit is included, thus bringing the reduced order model closer to the full mode (exact) description of the circuit, and yielding results which are closer to the exact behavior of the circuit.

The present invention comprises a methodology for sensitivity analysis in linear time-invariant circuits. This methodology exploits certain features of traditional sensitivity computation methods for linear circuits and combines them with the modal analysis and model-order reduction techniques. The result is a more robust sensitivity computation algorithm, or algorithms, characterized by efficiency, incrementality, and adaptability to particular applications.

The additional efficiency is derived from availability of analytic solutions, model order reduction and from proper sequencing of incremental computations. The invention emphasizes the application of these methods in the context of statistical timing analysis, however the results are applicable to linear circuit analysis in general.

The sensitivity results obtained here depend on certain basic properties of time-domain functions defined in terms of the input waveform and the exponential response of the system. Below is a description of the most important properties of these functions. Certain applicable functions are defined as follows:

$$\begin{matrix}{v}_{α} ( t ) ≡ {f}_{α} {\int }_{0}^{t} d {t}^{′} {e}^{- {f}_{α} ( t - {t}^{′} )} u ( {t}^{′} ) & ( 42 ) \\ {w}_{α} ( t ) ≡ {f}_{α} {\int }_{0}^{t} d {t}^{′} {e}^{- {f}_{α} ( t - {t}^{′} )} {v}_{α} ( {t}^{′} ) & ( 43 ) \\ {r}_{α} ( t ) ≡ {f}_{α} {\int }_{0}^{t} d {t}^{′} {e}^{- {f}_{α} ( t - {t}^{′} )} \dot{u} ( {t}^{′} ) & ( 44 ) \\ {s}_{α} ( t ) ≡ {f}_{α} {\int }_{0}^{t} d {t}^{′} {e}^{- {f}_{α} ( t - {t}^{′} )} {r}_{α} ( {t}^{′} ) & ( 45 ) \\ {z}_{α} ( t ) ≡ {f}_{α} {\int }_{0}^{t} d {t}^{′} {e}^{- {f}_{α} ( t - {t}^{′} )} \frac{\partial u ( {t}^{′} )}{\partial p } . & ( 46 )\end{matrix}$$

These functions all satisfy the same basic differential equation:

$${\dot{v}}_{α} ( t ) + {f}_{α} {v}_{α} ( t ) = {f}_{α} u ( t ) \\ {\dot{w}}_{α} ( t ) + {f}_{α} {w}_{α} ( t ) = {f}_{α} {v}_{α} ( t ) \\ {\dot{r}}_{α} ( t ) + {f}_{α} {r}_{α} ( t ) = {f}_{α} \dot{u} ( t ) \\ {\dot{s}}_{α} ( t ) + {f}_{α} {s}_{α} ( t ) = {f}_{α} {r}_{α} ( t ) \\ {\dot{z}}_{α} ( t ) + {f}_{α} {z}_{α} ( t ) = {f}_{α} \frac{\partial u ( t )}{\partial p} . \qquad ( 47 )$$

Assuming the input waveform u(0)=0, then

r_{α}(t)=\dot{v}_{α}(t)=f_{α}[u(t)−v_{α}(t)]

s_{α}(t)=\dot{w}_{α}(t⁾⁼f_{α}[v_{α}(t)−w_{α}(t)] (48)

Thus, once the computations for v_{α}(t) and w_{α}(t) are performed, r_{α}(t) and s_{α}(t) can be computed “for free,” that is, without incurring any significant additional computation time.

The function z_{α}(t) arises in the computation of sensitivities with respect to changes in the input waveform, such as sensitivity with respect to input slew.

In the course of the sensitivity analysis, the following functions are also encountered:

$$\begin{matrix}{w}_{α β} ( t ) ≡ {f}_{α} {\int }_{0}^{t} d {t}^{′} {e}^{- {f}_{α} ( t - {t}^{′} )} {v}_{β} ( {t}^{′} ) , & α \neq β \\ {s}_{α β} ( t ) ≡ {f}_{α} {\int }_{0}^{t} d {t}^{′} {e}^{- {f}_{α} ( t - {t}^{′} )} {r}_{β} ( {t}^{′} ) , & α \neq β .\end{matrix} \qquad ( 49 )$$

Using the differential equations that are implicit in the definitions of w_{αβ}(t) and s_{αβ}(t), the fact that these are not new functions, but instead are linear combinations of functions previously defined, can be shown, as follows:

$$\begin{matrix}{w}_{αβ} ( t ) = \frac{{f}_{α} {v}_{β} ( t ) - {f}_{β} {v}_{α} ( t )}{{f}_{α} - {f}_{β}} & ( 50 ) \\ {s}_{αβ} ( t ) = \frac{{f}_{α} {r}_{β} ( t ) - {f}_{β} {r}_{α} ( t )}{{f}_{α} - {f}_{β}} . & ( 51 )\end{matrix}$$

FIG. 10 is a qualitative illustration of the time-domain eigenfunctions for a ramp input shown as a function of time. As shown, the functions v and w approach unity for large time, while the functions r, s and z vanish for large time.

In the case of an input waveform of arbitrary shape, it is necessary to determine the time-domain eigenfunctions using numerical convolution of exponential response functions with the input waveform. This can be done in principal, and no doubt there are tricks that can be used to make the necessary convolutions more efficient than a straightforward approach. Nonetheless, the most natural application of the present technique are those cases where the input waveform is of relatively simple form, such as a step function, a saturated ramp, piecewise linear, or a simple exponential. In these cases, all of the time-domain eigenfunctions can be expressed analytically in closed form, and evaluated numerically using a small number of arithmetic and exponential operations.

One element of the sensitivity computation is the evaluation of the parameter β_{c} which is related to the time derivative of the node voltage of interest at the crossing time:

$${β}_{c} = \frac{1}{{e}^{T} \dot{x} ( {t}_{c} )} .$$

The evaluation of β_{c} requires knowledge of \dot{x}(t_{c}). Further, we can obtain \dot{x}(t_{c}) without the use of numerical derivatives by using Eq. (9) and taking a time derivative:

$$\dot{x} ( {t}_{c} ) = {\sum }_{α} {x}_{α} {\dot{v}}_{α} ( {t}_{c} ) = {\sum }_{α} {x}_{α} {f}_{α} [ u ( {t}_{c} ) - {v}_{α} ( {t}_{c} ) ]$$

where the differential equation for \dot{v}_{α}(t) shown in Eq. (47), above, has been used. Thus, only the evaluations of the input waveform u(t) and the eigenfunction v_{α} at the crossing time are necessary in order to calculate β_{c}.

The embodiments described are exemplary and are not meant to limit the scope of the invention. Those skilled in the art will understand that the invention can take forms other than those specifically described in regard to the above embodiments. For example, the invention can take the form of an entirely hardware embodiment, an entirely software embodiment or an embodiment containing both hardware and software elements. In one exemplary embodiment, the invention is implemented in software, which includes but is not limited to firmware, resident software, microcode, etc.

Furthermore, the invention can take the form of a computer program product accessible from a computer-usable or computer-readable medium providing program code for use by or in connection with a computer or any instruction execution system. For the purposes of this description, a computer-usable or computer readable medium can be any apparatus that can contain, store, communicate, propagate, or transport the program for use by or in connection with the instruction execution system, apparatus, or device.

The medium can be an electronic, magnetic, optical, electromagnetic, infrared, or semiconductor system (or apparatus or device) or a propagation medium. Examples of a computer-readable medium include a semiconductor or solid state memory, magnetic tape, a removable computer diskette, a random access memory (RAM), a read-only memory (ROM), a rigid magnetic disk and an optical disk. Current examples of optical disks include compact disk-read only memory (CD-ROM), compact disk-read/write (CD-R/W) and DVD.

A data processing system suitable for storing and/or executing program code will include at least one processor coupled directly or indirectly to memory elements through a system bus. The memory elements can include local memory employed during actual execution of the program code, bulk storage, and cache memories which provide temporary storage of at least some program code in order to reduce the number of times code must be retrieved from bulk storage during execution.

Input/output or I/O devices (including but not limited to keyboards, displays, pointing devices, etc.) can be coupled to the system either directly or through intervening I/O controllers.

Network adapters may also be coupled to the system to enable the data processing system to become coupled to other data processing systems or remote printers or storage devices through intervening private or public networks. Modems, cable modem and Ethernet cards are just a few of the currently available types of network adapters.

It would be understood that a method incorporating any combination of the details mentioned above would fall within the scope of the present invention as determined based upon the claims below and any equivalents thereof.

Other aspects, objects and advantages of the present invention can be obtained from a study of the drawings, the disclosure and the appended claims.

We claim:

1. A method for determining at least one sensitivity value of at least one output measurement of a linear circuit, the method comprising:
receiving an input signal, identification of at least one output measurement, and circuit-element sensitivity values corresponding to the linear circuit;
performing eigenvalue analysis of at least one linear circuit system matrix;
computing adjoint eigenvectors for each of at least one output measurement;
determining convolution eigenfunctions for the input signal;
evaluating values and/or integrals of convolution eigenfunctions associated with each of at least one output measurement; and
computing a weighted sum of products where the weights are based on the circuit-element sensitivity values to produce at least one sensitivity value of the output measurement.

2. The method of claim 1, further comprising:
receiving at least one changed circuit-element sensitivity value, and
repeating computing the weighted sum of products with different weights reflecting the change of at least one circuit-element sensitivity value to determine an updated sensitivity value of the output measurement.

3. The method of claim 1, further comprising:
receiving identification of a different output measurement,
when the different output measurement includes the node from the prior output measurement, repeating evaluating values and/or integrals of convolution eigenfunctions for the different output measurement, and computing weighted sum to determine the sensitivity value for the different output measurement, and
when the different output measurement includes a node different from the node of the prior output measurement, repeating computing adjoint eigenvectors for the different output measurement, evaluating values and/or integrals of convolution eigenfunctions and computing weighted sum steps to determine a second sensitivity value for the different output measurement.

4. The method of claim 1, further comprising:
receiving a modified input signal, and
repeating determining convolution eigenfunctions for the modified input signal,
evaluating values and/or integrals of convolution eigenfunctions and computing weighted sum steps to determine the updated sensitivity value.

5. The method of claim 1, wherein the at least one sensitivity value of the output measurement includes slew.

6. The method of claim 1, wherein the at least one sensitivity value of the output measurement includes delay.

7. The method of claim 1, wherein the at least one sensitivity value of the output measurement includes noise.

8. The method of claim 1, wherein the at least one sensitivity value of the output measurement includes power.

9. A method for determining at least one sensitivity value of at least one output measurement of a linear circuit, the method comprising:
receiving an input signal, identification of at least one output measurement, and circuit-element sensitivity values corresponding to the linear circuit;
determining a reduced-order model of the linear circuit system matrix;
computing at least one reduced-order linear circuit system matrix;
computing reduced-order circuit-element sensitivity values corresponding to the reduced-order model;
performing eigenvalue analysis of at least one reduced-order linear circuit system matrix;
computing adjoint eigenvectors for each of at least one output measurement;
determining convolution eigenfunctions for the input signal;
evaluating values and/or integrals of convolution eigenfunction associated with each of at least one output measurement; and
computing a weighted sum of products where the weights are based on the reduced-order circuit-element sensitivity values to produce at least one sensitivity value of the output measurement.

10. The method of claim 9, further comprising:
receiving at least one changed circuit-element sensitivity value,
determining the reduced-order model of the linear circuit system matrix,
computing at least one reduced-order linear circuit system matrix,
computing reduced-order circuit-element sensitivity values corresponding to the reduced-order model, and
repeating computing the weighted sum of products with different weights reflecting the change of at least one circuit-element sensitivity value to determine an updated sensitivity value of the output measurement.

11. The method of claim 9, further comprising:
receiving identification of a different output measurement,
when the different output measurement includes the node from the prior output measurement, repeating evaluating values and/or integrals of convolution eigenfunctions for the different output measurement, and computing weighted sum to determine the sensitivity value for the different output measurement, and
when the different output measurement includes a node different from the node of the prior output measurement, repeating computing adjoint eigenvectors for the different output measurement, evaluating values and/or integrals of convolution eigenfunction and computing weighted sum steps to determine a second sensitivity value for the different output measurement.

12. The method of claim 9, further comprising:
receiving a modified input signal, and
repeating determining convolution eigenfunctions for the modified input signal, evaluating values and/or integrals of convolution eigenfunction and computing weighted sum steps to determine the updated sensitivity value.

13. The method of claim 9, wherein the at least one sensitivity value of the output measurement includes slew.

14. The method of claim 9, wherein the at least one sensitivity value of the output measurement includes delay.

15. The method of claim 9, wherein the at least one sensitivity value of the output measurement includes noise.

16. The method of claim 9, wherein the at least one sensitivity value of the output measurement includes power.

17. A computer program product for determining a sensitivity value of an interconnect circuit, the computer program product comprising:
a computer readable medium;
first program instruction means for receiving an input signal, identification of at least one output measurement, and circuit-element sensitivity values corresponding to the linear circuit;
second program instruction means for performing eigenvalue analysis of at least one linear circuit system matrix;
third program instruction means for computing adjoint eigenvectors for each of at least one output measurement;
fourth program instruction means for determining convolution eigenfunctions for the input signal;
fifth program instruction means for evaluating values and/or integrals of convolution eigenfunctions associated with each of at least one output measurement; and
sixth program instruction means for computing a weighted sum of products where the weights are based on the circuit-element sensitivity values to produce at least one sensitivity value of the output measurement.

18. A computer program product for determining a sensitivity value of an interconnect circuit, the computer program product comprising:
a computer readable medium;
first program instruction means for receiving an input signal, identification of at least one output measurement, and circuit-element sensitivity values corresponding to the linear circuit;
a second program instruction means for determining a reduced-order model of the linear circuit system matrix;
a third program instruction means for computing at least one reduced-order linear circuit system matrix;
a fourth program instruction means for computing reduced-order circuit-element sensitivity values corresponding to the reduced-order model;
a fifth program instruction means for performing eigenvalue analysis of at least one reduced-order linear circuit system matrix;
a sixth program instruction means for computing adjoint eigenvectors for each of at least one output measurement;
a seventh program instruction means for determining convolution eigenfunctions for the input signal;
a eighth program instruction means for evaluating values and/or integrals of convolution eigenfunction associated with each of at least one output measurement; and
a ninth program instruction means for computing a weighted sum of products where the weights are based on the reduced-order circuit-element sensitivity values to produce at least one sensitivity value of the output measurement.
